(19) United States
(12) Patent Application Publication
(10) Pub. No.: US 2024/0036577 A1
(43) Pub. Date: Feb. 1, 2024

(54) Device Management And Configuration

(71) Applicant: APPLE INC., Cupertino, CA (US)

(72) Inventor: Libo Cao Meyers, San Jose, CA (US)

(21) Appl. No.: 18/377,928

(22) Filed: Oct. 9, 2023

Related U.S. Application Data
(63) Continuation of application No. PCT/US2022/029851, filed on May 18, 2022.
(60) Provisional application No. 63/192,283, filed on May 24, 2021.

(51) Int. Cl. G05D 1/02; G06F 21/31; G06Q 50/30

(52) U.S. Cl. CPC G05D 1/021; G06F 21/31; G06Q 50/30

(57) ABSTRACT

Techniques include transferring control of a device from a provider entity to a user and transferring control of the device from the user to the provider entity.

### CROSS-REFERENCE TO RELATED APPLICATIONS

This application is a continuation of International Application No. PCT/US2022/029851, filed on May 18, 2022, which claims the benefit of U.S. Provisional Application No. 63/192,283, filed on May 24, 2021, the contents of which are hereby incorporated by reference in their entireties for all purposes.

### FIELD

The present disclosure relates generally to the field of device management and configuration.

### BACKGROUND

In some known systems, control of a device can be assigned to a user, and control of the device can subsequently be returned to the system.

### SUMMARY

An aspect of the disclosure is an apparatus that includes one or more processors coupled to a memory and a motion actuator, wherein the memory comprises instructions that, when performed using the one or more processors, cause the apparatus to receive an assignment request, wherein the assignment request specifies a usage period, of the apparatus, for a user, and authenticate a potential user, in accordance with the assignment request, as the user associated with the usage period. The instructions further cause the apparatus to move, using the motion actuator, towards a destination in accordance with input specified by the authenticated user and a motion plan determined using the one or more processors, and in accordance with arrival at the destination and a determination that the usage period has expired, delete the input specified by the authenticated user from the memory.

In some implementations, the instructions further cause the apparatus to, in accordance with a determination that the usage period has not expired, retaining at least portions of the input specified by the authenticated user in the memory, beyond arrival at the destination. In some implementations, the instructions further cause the apparatus to, in accordance with a determination that the usage period has expired, deleting input provided by the authenticated user during the usage period from the memory. In some implementations, the instructions further cause the apparatus to, configuring the apparatus according to preferences associated with the user, before authenticating the potential user as the user, and wherein deleting the input specified by the authenticated user comprises deleting data representing the preferences from the memory. The input specified by the authenticated user may include the destination.

In some implementations, the instructions further cause the apparatus to present, on a display, an indication that information associated with the authenticated user are deleted on arrival at the destination. In some implementations, the instructions further cause the apparatus to, in accordance with receiving a device un-assignment request during the usage period, delete information associated with the user from the memory, before the end of the usage period.

Another aspect of the disclosure is a method that includes, at an electronic device having memory and a motion actuator coupled to one or more processors, receiving an assignment request, wherein the assignment request specifies a usage period, of the electronic device, for a user, and authenticating a potential user, in accordance with the assignment request, as the user associated with the usage period. The method further includes moving, using the motion actuator, towards a destination in accordance with input specified by the authenticated user and a motion plan determined using the one or more processors; and in accordance with arrival at the destination and a determination that the usage period has expired, deleting the input specified by the authenticated user from the memory of the electronic device.

Another aspect of the disclosure is a non-transitory computer-readable storage device including program instructions executable by one or more processors of an electronic device that, when executed, cause the electronic device to perform operations. The operations comprise receiving, an assignment request, wherein the assignment request specifies a usage period, of the electronic device, for a user, and authenticating a potential user, in accordance with the assignment request, as the user associated with the usage period. The operations further comprise moving, using the motion actuator, towards a destination in accordance with input specified by the authenticated user and a motion plan determined using the one or more processors, and in accordance with arrival at the destination and a determination that the usage period has expired, deleting the input specified by the authenticated user from the memory of the electronic device. Another aspect of the disclosure is a method that includes receiving, by a provider entity, a device assignment request from a user and selecting, by the provider entity, a transportation device from a group of available devices, wherein the available devices are in an unassigned state in which the available devices are under control of the provider entity. The method also includes transitioning the transportation device from the unassigned state to an assigned state, and moving the transportation device to a user location. The method also includes authenticating the user subsequent to arrival of the transportation device at the user location, allowing the user to access the transportation device in response to successful authentication of the user, and operating one or more functions of the transportation device according to commands received from the user.

In some implementations of the method, moving the transportation device to the user location is performed by the transportation device under autonomous control using actuators that are associated with the transportation device. Some implementations of the method include configuring the transportation device according to user information that is associated with the user, after receiving the device assignment request. In some implementations of the method, the user information is stored by the provider entity and is transmitted to the transportation device by the provider entity. In some implementations of the method, the user information is stored by a user device and is transmitted to the transportation device by the user device.

In some implementations of the method, the user location is a location that is specified by the user. In some implementations of the method, the user location is a location associated with a user device. In some implementations of the method, authenticating the user includes receiving a transmission of authentication information from a user device. In some implementations of the method, authenticating the user includes receiving a user input at an input device that is associated with the transportation device. The user input may include a username and password. The user input may include a passcode that is transmitted from the provider entity to a user device. The user input may include a passcode that is transmitted from the transportation device to a user device. The input device may be an audio input device and the user input may be spoken by the user. In some implementations of the method, authenticating the user includes obtaining a biometric identifier using a biometric scanner that is associated with the transportation device. In some implementations of the method, authenticating the user includes displaying a passcode to the user using a display device that is associated with the transportation device.

Some implementations of the method also include deleting all stored user information from the transportation device at a conclusion of a usage period. In some implementations of the method, the conclusion of the usage period corresponds to arrival at a destination location. In some implementations of the method, the conclusion of the usage period corresponds to a predefined end time associated with the usage period. In some implementations, the conclusion of the usage period corresponds to a transition of transportation device to the unassigned state from the assigned state.

Another aspect of the disclosure is a non-transitory computer-readable storage device including program instructions executable by one or more processors that, when executed, cause the one or more processors to perform operations. The operations include receiving, by a provider entity, a device assignment request from a user, and selecting, by the provider entity, a transportation device from a group of available devices, wherein the available devices are in an unassigned state in which the available devices are under control of the provider entity. The operations also include transitioning the transportation device from the unassigned state to an assigned state and moving the transportation device to a user location. The operations also include authenticating the user subsequent to arrival of the transportation device at the user location, allowing the user to access the transportation device in response to successful authentication of the user, and operating one or more functions of the transportation device according to commands received from the user.

Another aspect of the disclosure is an apparatus that includes a memory, and one or more processors that are configured to execute instructions that are stored in the memory. The instructions, when executed, cause the one or more processors to receive, by a provider entity, a device assignment request from a user, and select, by the provider entity, a transportation device from a group of available devices, wherein the available devices are in an unassigned state in which the available devices are under control of the provider entity. The instructions further cause the one or more processors to transition the transportation device from the unassigned state to an assigned state, and move the transportation device to a user location. The instructions further cause the one or more processors to authenticate the user subsequent to arrival of the transportation device at the user location, allow the user to access the transportation device in response to successful authentication of the user, and operate one or more functions of the transportation device according to commands received from the user.

Another aspect of the disclosure is a method that includes receiving, by a provider entity, a request to transition a transportation device to an unassigned state from an assigned state, and preparing the transportation device to transition to the unassigned state by performing one or more actions. The one or more actions include deleting all stored user information from the transportation device. The method also includes transitioning the transportation device from the assigned state to the unassigned state only upon determining that all of the one or more actions have been completed.

In some implementations of the method, the request to transition the transportation device to the unassigned state from the assigned state is made by a user through a user device. In some implementations of the method, the request to transition the transportation device to the unassigned state from the assigned state is made by a user through and interface device that is associated with the transportation device. In some implementations of the method, the request to transition the transportation device to the unassigned state from the assigned state is made by the transportation device. In some implementations of the method, the request to transition the transportation device to the unassigned state from the assigned state is made by the provider entity. In some implementations of the method, the request to transition the transportation device to the unassigned state from the assigned state is made by at least one of the provider entity or the transportation device and the one or more actions include receiving confirmation from a user that the user is ready to allow transition of the transportation device from the assigned state to the unassigned state. In some implementations of the method, the one or more actions include determining whether one or more conditions for transition to the unassigned state are satisfied according to a status of the transportation device.

Another aspect of the disclosure is a non-transitory computer-readable storage device including program instructions executable by one or more processors that, when executed, cause the one or more processors to perform operations. The operations include receiving, by a provider entity, a request to transition a transportation device to an unassigned state from an assigned state, and preparing the transportation device to transition to the unassigned state by performing one or more actions. The one or more actions include deleting all stored user information from the transportation device. The operations also include transitioning the transportation device from the assigned state to the unassigned state only upon determining that all of the one or more actions have been completed.

Another aspect of the disclosure is an apparatus that includes a memory, and one or more processors that are configured to execute instructions that are stored in the memory. The instructions, when executed, cause the one or more processors to receive, by a provider entity, a request to transition a transportation device to an unassigned state from an assigned state, and prepare the transportation device to transition to the unassigned state by performing one or more actions. The one or more actions include deleting all stored user information from the transportation device. The instructions further cause the one or more processors to transition the transportation device from the assigned state to unassigned state only upon determining that all of the one or more actions have been completed.

### BRIEF DESCRIPTION OF THE DRAWINGS

FIG. 1 is a block diagram of a system in accordance with some embodiments.

FIG. 2 is a block diagram of a provider entity in accordance with some embodiments.

FIG. 3 is a block diagram of a device in accordance with some embodiments.

FIG. 4 is a block diagram of a process for transitioning from an unassigned state to an assigned state in accordance with some embodiments.

FIG. 5 is a block diagram of a process for authentication in accordance with some embodiments.

FIG. 6 is a block diagram of a process for transitioning from the assigned state to an unassigned state in accordance with some embodiments.

FIG. 7 is a block diagram of an exemplary computing device in accordance with some embodiments.

### DETAILED DESCRIPTION

The description herein relates to devices that are managed by a provider entity and provided from a device pool to users on a temporary basis. Providing, or assigning, a device to a user includes transitioning the device from an unassigned state to an assigned state. This may include selecting the device and delivering the device to the user. Delivering the device to the user may include making the device, configuring the device, moving the device, authenticating the user, and/or pairing the device with a user device. After the device is delivered to the user, the user may operate the device, such as by issuing commands to the device. As an example, the user may command the device to move from a current location toward a user-specified destination location. Returning the device from user control to control by the provider entity may include a request to return the device to the unassigned state, preparing to return the device, and transitioning the device from the assigned state to the unassigned state. Preparing the device to transition from the assigned state to the unassigned state may include confirming the request, checking a status of the device, and deleting user information from the device. In some embodiments, the provider entity designs and manufactures the product device. In some embodiments, the provider entity is a service provider. In some embodiments, the provider entity carries on aspects of design, manufacture, and/or service provision.

As used herein, the term “user” refers to a person who is able to exercise primary control over a device and utilize the features and functionality of the device. A user may be an owner of the device or a non-owner who is permitted to use the device. As an example, an owner may authorize use by another person, and that person will be the user of the device until their use of the device ends. As another example, the provider entity may be the owner of the device, and the users are persons who are authorized to use the device by the provider entity. As another example, the owner may be a person who places their device into the device pool, and allows the provider entity to assign the device to other persons, who are then the users. Although the terms user and owner appear herein in the singular form, it should be understood that the plural forms are intended to be encompassed by usage of the words owner and user. Thus, for example, a single device may concurrently have more than one owner or user.

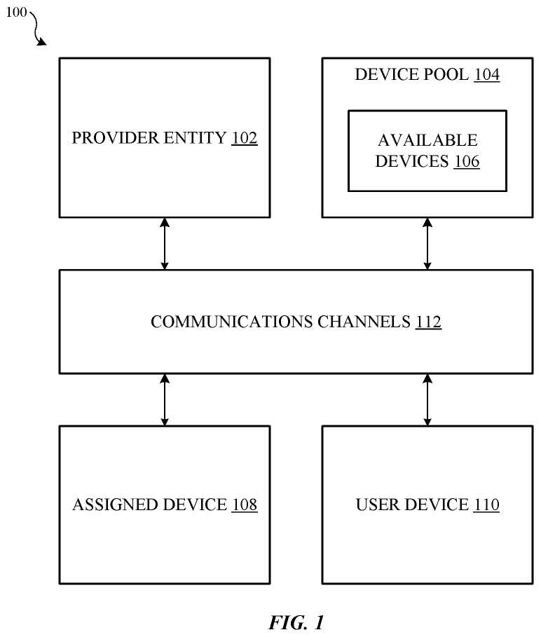

FIG. 1 is a block diagram of a system 100 that includes a provider entity 102, a device pool 104 of available devices 106, an assigned device 108, a user device 110, and communications channels 112. The provider entity 102, the available devices 106, the assigned device 108, and the user device 110 may communicate (e.g., by transmission of signals and/or data) with each other using wired or wireless connections and using any type of communications network, such as the Internet, and/or direct communications using any type of short range communications system. In some embodiments, the available devices 106 and the assigned device 108 are vehicles, and the user device 110 is a smart cellular phone.

The provider entity 102 is configured to manage devices that are associated with the device pool 104. The provider entity 102 may manage a large number (e.g., thousands) of devices that are associated with the device pool 104, including the available devices 106 and the assigned device 108. These devices may be transportation devices that are configured to move under their own power and optionally carry cargo and/or passengers. To manage the devices, the provider entity 102 may be configured to receive information from the available devices 106 and/or the assigned device 108, configured to send information from the available devices 106 and/or the assigned device 108, configured to send commands to the available devices 106 and/or the assigned device 108, configured to receive requests from the available devices 106 and/or the assigned device 108, configured to send information to the user device 110, configured to receive information from the user device 110, and/or configured to receive requests from the user device 110. The provider entity 102 may also make determinations relating to the available devices 106 and/or the assigned device 108. As one example, the determinations may be made in response to requests received from the available devices 106, the assigned device 108, and/or the user device. As another example, the determinations may be made in accordance with the functions of the provider entity 102, such as by making a determination in response to receiving specific types of information or in response to determining that sensed or received information indicates that a condition is satisfied.

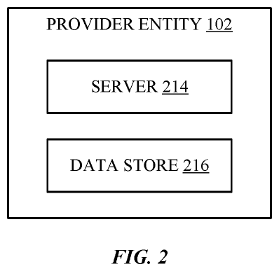

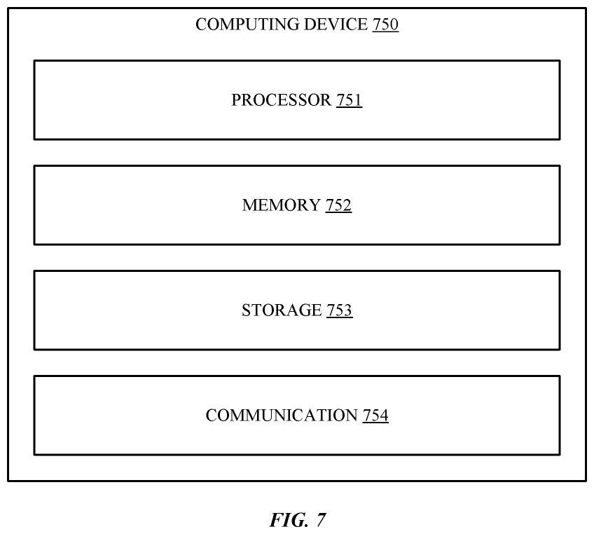

FIG. 2 is block diagram of the provider entity 102 according to an example. In the illustrated example, the provider entity 102 includes a server 214 (e.g., one or more servers) and a data store 216. The server 214 is a computing device or multiple computing devices that are configured to implement the functions that are associated with the provider entity 102. Operations and functions that are described herein with reference to the provider entity 102 may be performed by the server 214. These functions may be implemented in the form of computer program instructions that are stored by the server 214, by the data store 216, or by another data storage device, and are executable by the server 214. The data store 216 includes one or more data storage devices that are configured to store information that is collected and/or used by the provider entity 102. In some implementations, the server 214 and/or the data store 216 employ exemplary computing device 750 described with reference to FIG. 7, below.

The devices that are managed by the provider entity 102 are able to transition between an unassigned state, which is represented by the available devices 106, and an assigned state, which is represented by the assigned device 108. Thus, when a particular device is in the unassigned state, it is part of the device pool 104 and is represented by the available devices 106, and when the device is in the assigned state, it is no longer part of the device pool 104 and is represented by the assigned device 108.

The device pool 104 is a collective term for devices that are in the unassigned state, which are represented herein by the available devices 106. Devices are considered to be part of the device pool 104 when they are in the unassigned state, and devices are not considered to be part of the device pool 104 when they are in the assigned state. Thus, the assigned device 108 is not considered to be part of the device pool 104 but may transition from the assigned state to the unassigned state, at which point it becomes one of the available devices 106 and therefore part of the device pool 104. Conversely, the available devices 106 of that are part of the device pool 104 may be available for transition from the unassigned state to the assigned state.

The assigned device 108 is assigned to a particular user (e.g., through a user account) who is able to exercise primary control over the assigned device 108 and utilize the features and functionality of the assigned device 108. The user to whom the assigned device 108 is assigned may authorize additional users to exercise control over the assigned device 108. Under normal operating circumstances, the provider entity 102 is not able to exercise control over the assigned device 108. In some situations, the provider entity 102 cannot, without authorization from the user, return the assigned device 108 to the device pool 104 by causing the assigned device 108 to transition to the unassigned state. Specific examples will be described further herein.

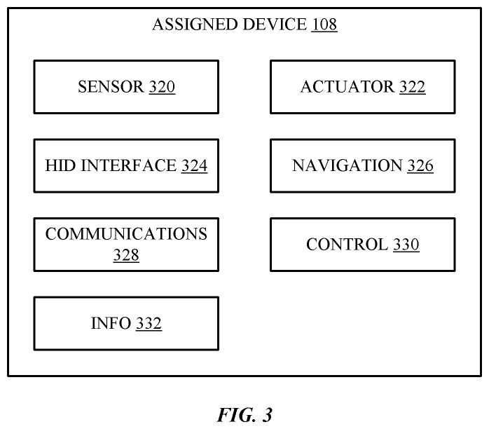

FIG. 3 is a block diagram of the assigned device 108 according to an example. The same configuration may be used for the available devices 106. In some embodiments, the assigned device 108 is a road-going vehicle (e.g., supported by wheels and tires) that is configured to carry passengers and/or cargo. In some examples, the assigned device 108 includes a sensor system 320, an actuator system 322, a human interface device (HID) interface 324, a navigation system 326, a communications system 328, a control system 330, and an infotainment system 332. These components are attached to and/or form parts of a physical structure of the assigned device 108, such as a body or frame, and are electrically interconnected to allow transmission of signals, data, commands, etc., between them, either over wired connections, (e.g., using a wired communications bus) or over wireless data communications channels. Other components may be included in the assigned device 108, including chassis, body, suspension, actuator, power system components, so forth. The structural components of the assigned device 108 may define a passenger compartment and/or a luggage compartment.

The sensor system 320 includes one or more sensor components that are able to collect information that describes the environment around the assigned device 108, conditions inside the passenger compartment of the assigned device, and/or information that describes operating conditions of the assigned device 108 in order to support functions of the assigned device 108 such as autonomous operation by the control system 330. The information may be in the form of sensor signals that represent measurements and/or observations. Exemplary sensors in the sensor system 320 for information include imaging devices such as still cameras in the visible spectrum or the infrared spectrum, video cameras, Lidar or other depth sensors, Radar sensors, GPS sensors, inertial measurement units, position sensors, angle sensors, speed sensors, torque sensors, force sensors, so forth.

The actuator system 322 includes one or more actuator components that are able to affect motion of the assigned device 108. The actuator components can accelerate, decelerate, steer, or otherwise influence motion of the assigned device 108. These components can include suspension actuators, steering actuators, braking actuators, and propulsion actuators (e.g., one or more electric motors).

The HID interface 324 includes components that allow a user to interact with various system of the assigned device 108. The HID interface 324 includes input devices and output devices. Examples of HID interface 324 include display screens, touch-sensitive interfaces, gesture interfaces, audio output devices, voice command interfaces, buttons, knobs, control sticks, control wheels, pedals, so forth. The HID interface 324 may allow the user to control the navigation system 326, such as by specifying a destination for the assigned device 108.

The navigation system 326 may include location determining functionality, mapping functionality, and route planning functionality. As an example, the navigation system 326 may include a satellite positing system receiver to determine a current location of the assigned device 108. The navigation system 326 is also configured to determine and/or display one or more routes from a current location to a destination including display of geographic areas near the one or more routes. The navigation system 326 may be operable to receive a route from the user (e.g., passenger), to receive a route from an external route planning system, or to plan a route based on user inputs. As an example, the navigation system 326 may use a routing algorithm of any type to determine a route from an origin location (e.g., a current location or a user-specified location) to a destination location. The route may be determined locally by the navigation system 326 using an on-board routing algorithm or may be determined remotely (e.g., by a navigation routing server). The route may be stored in any suitable data format, for example, such as a list of map segments or road segments that connect the origin location to the destination location.

The communications system 328 allows signals carrying data to be transmitted from the assigned device 108 to remote systems and/or received at the assigned device 108 from remote systems. Any suitable communications protocol and/or technology may be utilized to implement the communications system 328, such as cellular protocols. As an example, the communications system 328 allows real-time communications between the assigned device 108 and the provider entity 102.

The control system 330 is configured to control motion of the assigned device 108, for example, by controlling of operation of the actuator system 322. As one example, the control system 330 may implement an autonomous control mode in which the actuator system 322 is controlled (e.g., according to computer program instructions and based on sensor outputs) to cause motion of the assigned device 108 toward a destination (e.g., selected using the navigation system 326). As another example, the control system 330 may implement a remote control mode in which commands for controlling operation of some or all functions of the actuator system 322 are received from a remote location in response to inputs from a human operator at the remote location. As another example, the control system 330 may implement a manual control mode in which a person who is traveling using the assigned device 108 controls some or all functions of the actuator systems by control input made through the HID interface 324. In some implementations, the control system 330 employs exemplary computing device 750 described with reference to FIG. 7, below.

The user device 110 is a device that is associated with a user and/or a user account. The user device is a computing device that incorporates input functionality, output functionality, and communications functionality. As examples, the user device 110 may be a smart telephone, a tablet computer, a laptop computer, or other type of computing device. In some implementations, the user device 110 is configured according to the description of exemplary computing device 750 described with reference to FIG. 7, below.

The system 100 may be configured to perform various processes in support of management of the device pool 104, the available devices, 106, and/or the assigned device 108. Specific examples of such processes will be described further herein. Such processes can be implemented using one or more computing devices, such as computing devices associated with the provider entity 102, the available devices 106, the assigned device 108, and/or the user device 110. As an example, the processes described herein and the steps thereof may be implemented in the form of computer program instructions that are executable by one or more computing devices, wherein the instructions, when executed by the one or more computing devices, cause the one or more computing devices to perform functions that correspond to the steps of the processes.

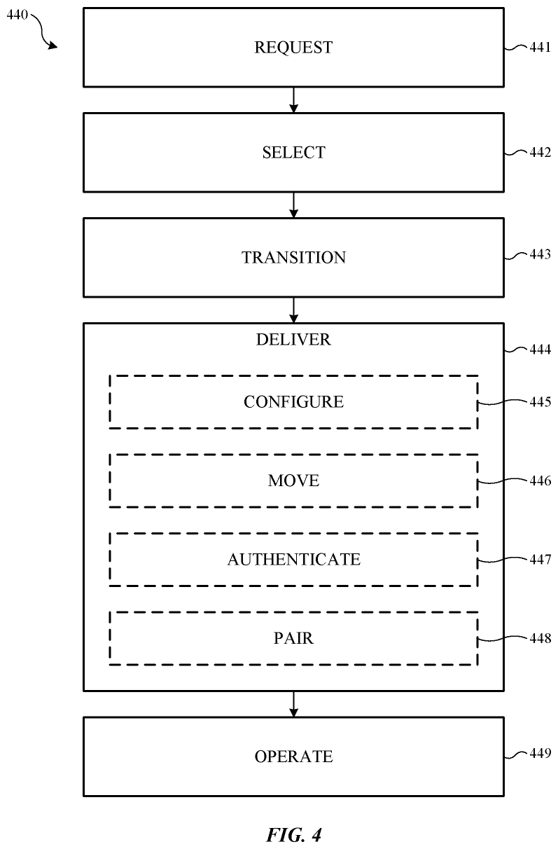

FIG. 4 is a block diagram of a process 440 for transitioning a device from the unassigned state to the assigned state. As an example, the process 440 may include receiving a request for assignment of a device, selecting a device for assignment, transitioning the selected device from the unassigned state to the assigned state, delivering the device, and operating the device in accordance with commands while in the assigned state.

In operation 441, a request for assignment of a device is received. This request may be referred to as a device assignment request. The device assignment request may be received by the provider entity 102, for example, in the form of a transmission from a device and/or location that is external to the provider entity 102, where the transmission is received by the provider entity 102 using the communications channels 112. The request may be made by a user on may be made on behalf of a user. Thus, the request may be associated with a user account that is controlled by the user. As an example, the request may be made by a user through use of the user device 110, such as by submission of the request using an application that is executed by the user device 110.

The request may include information that defines what the user is requesting from the provider entity 102. As an example, the request may ask for usage of one of the available devices 106 from the device pool 104, the request may specify a start time for a usage period, the request may specify an end time for the usage period, the request may specify a duration of the usage period, the request may specify a start location (e.g., a current location of the user and/or the user device 110 or another location), and the request may specify and end location for the usage period.

The request for assignment of a device in operation 441 need not specify a particular device that is to be assigned to the user, and instead, the particular device may be selected by the provider entity 102 according to operation 442. In some implementations, however, a particular device (e.g., one of the available devices 106) may be requested by the user. As an example, a user may request a specific device using a user interface displayed on the user device 110 that transmits a request to the provider entity 102 specifying the device. As an example, the user may request a specific device by a communication connection between the user device and the specific device (e.g., from the available devices) As an example, the user may request a specific device through use of a user interface device that is associated with the specific device (e.g., one of the available devices 106), such as an interface device that is accessible from outside the device or from inside a passenger compartment of the device.

The request for assignment of a device in operation 441 may specify a duration for usage of the device by the user. As one example, the duration may be specified as a time period, such as a number of hours, a number of days, a number of weeks, a number of months, or a date and/or time on which the time period concludes. As another example, the duration may be specified in terms of a destination, where the usage period ends when the device has transported the user (or user-specified passengers or cargo) to the destination.

In operation 442, a device is selected for assignment. The provider entity 102 may select one of the available devices 106 from the device pool 104 to be assigned to the user in response to the request. The available devices 106 that may be selected for assignment in operation 442 are devices that are in the unassigned state, are not assigned to any user, and are under control of the provider entity 102 as part of the device pool 104.

A specific one of the available devices 106 may be selected in operation 442 based on one or more factors. As one example, the selection may be based on information that is included in the request that specifies characteristics for the device, such as passenger capacity that is specified in the request or a cargo capacity that is specified in the request. As another example, the selection may be made based on a comparison of the start location for the usage period (e.g., as specified in the request) and the current locations of one or more of the available devices 106 from the device pool 104.

In another implementation of operation 442, the request from operation 441 may specify a specific one of the available devices 106 from the device pool 104. As an example, the user may request a device that is present at the user's current location. As an example, the user may request a device by using sensors of the user device 110 to scan a code that is affixed on the device. As an example, the user may request a device by specifying the device in the request using identifying information, such as a unique identifier that is associated with the device. In such a scenario, the provider entity 102 may assign the requested device to the user in accordance with the user selection subject to confirmation of availability of the selected device and/or satisfaction of other criteria as determined by the provider entity 102.

In operation 443, the device that was selected for assignment in operation 442 is transitioned from the unassigned state to the assigned state. As a result of operation 443, the respective device is no longer one of the available devices 106 and instead functions as the assigned device 108. Accordingly, the respective device is no longer currently part of the device pool 104 and is not available for assignment to other users. In the description herein, transition from the unassigned state to the assigned state is described as occurring prior to delivering the assigned device 108 to the user in accordance with operation 444 and its sub-operations. It should be understood that order of these operations can be modified, and some operations may be performed concurrently.

In operation 444, the assigned device 108 is delivered to the user so that the user may take control of the assigned device 108. Operation 444 may include optional sub-operations that are performed as part of delivering the assigned device 108 to the user. In particular, operation 444 may include configuring the assigned device 108 for the user in sub-operation 445, moving the assigned device 108 to the user in sub-operation 446, authenticating the user in optional sub-operation 447, and pairing the assigned device 108 to the user device 110 in optional sub-operation 448.

In sub-operation 445, the assigned device 108 is configured for the user. As an example, sub-operation 445 may include configuring the assigned device 108 according to one or more settings or preferences that are associated with the user. User-specific settings or preferences may be stored by the provider entity 102 with consent received from the user. As an example, the user-specific settings or preferences may be stored in the data store 216 of the provider entity 102, and the stored settings may be accessed at the data store 216 and transferred to the assigned device 108 or otherwise used for configuring the assigned device 108 in sub-operation 445. As another example, the user-specific settings or preferences may be stored by the user device 110 and transferred from the user device 110 to the provider entity 102 and/or the assigned device 108 in order to configure the assigned device 108 in sub-operation 445.

In sub-operation 446, the assigned device 108 is moved to the user. Moving the assigned device 108 is performed to allow the user to access the assigned device 108 and is performed under direction from the user based on information that indicates a specified location. The information that specifies the current location may be received from the user device 110 based on a user input, or automatically, based on a location signal (e.g., a satellite positioning signal) that describes a current location of the user device 110. As an example, the assigned device 108 may move under autonomous control from a current destination of the assigned device 108 toward a specified destination location, such as a location that is near a current location of the user. The specified destination location may be manually selected by the user or may be selected by the provider entity 102 and/or the assigned device 108, for example, based on a current position of the user and/or other information.

In sub-operation 447, the identity of the user is authenticated. In some situations, authenticating the identity of the user occurs while a potential user is physically present near the assigned device 108 and is performed, for example, prior to permitting the user to access the assigned device 108 as an authenticated user. As an example, permitting the user to access the assigned device 108 may include opening a passenger compartment door of the assigned device 108, opening a cargo compartment door of the assigned device 108, allowing the user to enter a passenger compartment of the assigned device 108, allowing the user to place an item into a cargo compartment of the assigned device 108, and/or allowing the user to remove an item from the cargo compartment of the assigned device 108.

In sub-operation 448, the assigned device 108 is paired with a device that is associated with the user or a person who has been authorized by the user to control the assigned device 108. As an example, the assigned device 108 can be paired with the user device 110. As used here, pairing refers to establishing a communications connection between two devices for transferring information between them and for allowing one device (e.g., the user device 110) to exercise control over the other device (e.g., the assigned device 108) by transmitting commands or in other suitable ways.

In operation 449 the assigned device 108 is operated in accordance with commands. Operation 449 may include operating one or more functions of the assigned device 108 according to commands received from the user. The one or more functions of the assigned device 108 may include any functions performed by systems or components that are associated with the assigned device 108, as previously described. As an example, one or more functions of the assigned device 108 may include selecting a destination for the assigned device 108 and causing the assigned device 108 to travel (e.g., under autonomous control) from a current location of the assigned device 108 to the selected destination.

The commands used to operate the assigned device 108 in operation 449 may be issued by a person who is authorized to control the assigned device 108. As one example, the authorized person may be the user to whom the assigned device 108 was assigned in operation 443, in which case, the commands are issued to the assigned device 108 by the user and the assigned device 108 is operated in accordance with commands that are received from the user. Alternatively, the user may authorize another person (e.g., a family member) to operate the assigned device 108, which case the assigned device 108 is operated in accordance with commands received from an authorized person other than the user.

Operation of the assigned device 108 in operation 449 may include causing the assigned device 108 to travel from a current location toward a destination by controlling the assigned device using an interface device that is associated with the assigned device 108 or using the user device 110. As an example, the destination may be specified by the user using an interface that is associated with the assigned device 108 or using the user device 110, and the user may issue a command that causes the assigned device 108 to start traveling toward the destination.

While the assigned device 108 is in the assigned state, the user may transfer control to an authorized person. This may be referred to as a sub-assigned state. In the sub-assigned state, the authorized person is able to use the assigned device any may be able to control some or all of the features of the assigned device 108. Usage of the assigned device 108 in the sub-assigned state may be subject to restrictions imposed by the user. As one example, the user may limit travel of the assigned device to a predetermined geographical area or to a predetermined list of destinations. As another example, the user may restrict that number of persons who may travel in the assigned device 108 with the authorized user and/or may restrict travel in the assigned device to a list of approved persons. Access to user information may be restricted while in the sub-assigned state. As an example, by selection of settings that cause the assigned device 108 to modify how the user information is stored and/or accessed, the user may restrict access to some user information that is stored by the assigned device 108 in the sub-assigned state, the user may restrict access to all user information that is stored by the assigned device 108 in the sub-assigned state, or the user may cause all of the user information to be deleted from the assigned device 108 in the sub-assigned state.

An implementation of the process 440 includes receiving an assignment request, wherein the assignment request specifies a usage period, of the electronic device (e.g., the assigned device 108), for a user. The assignment request may be received at the electronic device subsequent to receipt of the assignment request by the provider entity 102 and selection of the electronic device by the provider entity 102, which may be implemented according to operation 441 and 442, Upon reaching the location of the user, the process 440 includes authenticating a potential user, in accordance with the assignment request, as the user associated with the usage period. Subsequent to authentication, the process includes moving the electronic device, using the motion actuator (e.g., one or more actuators from the actuator system 322, towards a destination in accordance with input specified by the authenticated user and a motion plan determined using one or more processors, which may be performed in the manner described with respect to operation 449. In accordance with arrival at the destination and a determination that the usage period has expired, the process includes deleting the input specified by the authenticated user from the memory of the electronic device. In accordance with a determination that the usage period has not expired, the process includes retaining at least portions of the input specified by the authenticated user in the memory of the electronic device, beyond arrival at the destination. In accordance with a determination that the usage period has expired, the process includes deleting input provided by the authenticated user during the usage period from the memory of the electronic device. The process may include configuring the electronic device according to preferences associated with the user, before authenticating the potential user as the user, and in such implementations, deleting the input specified by the authenticated user may include deleting data representing the preferences from the memory of the electronic device. As an example, the input specified by the authenticated user may include the destination. The process may include presenting, on a display, an indication that information associated with the authenticated user are deleted on arrival at the destination. The process may include, in accordance with receiving a device un-assignment request during the usage period, deleting information associated with the user from the memory, before the end of the usage period.

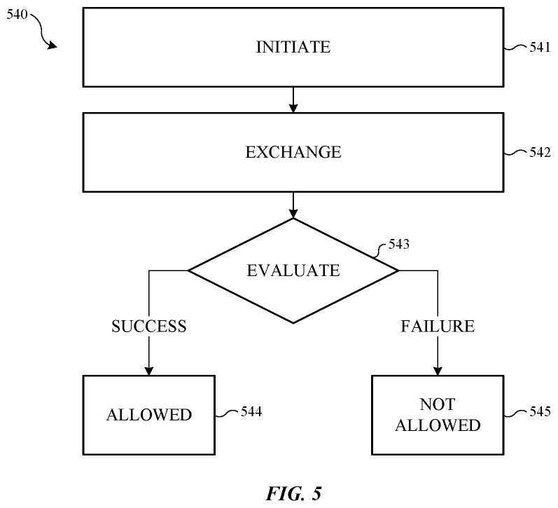

FIG. 5 is a block diagram of a process 540 for authenticating the user in order to provide the user access to and/or control over the assigned device 108. The process 540 may be used as an implementation of sub-operation 446 of the process 440 in order to authenticate the identity of a user as part of the process 440. The process 540 includes initiating an authentication procedure in operation 541, exchanging authentication information in operation 542, evaluating the authentication information in operation 543, and either allowing access and/or use of the assigned device 108 in operation 544 in response to determining a successful authentication result or not allowing access and/or use of the assigned device 108 in operation 545 in response to a failed authentication result.

In operation 541, the authentication procedure is initiated. The authentication procedure may be initiated in response to a request, in response to satisfaction of a condition, or otherwise. As an example, the authentication procedure may be initiated when the user is located near the assigned device 108. As an example, the authentication procedure may be initiated when the user approaches the assigned device 108. As an example, the authentication procedure may be initiated in response to a user input made at the assigned device 108, such as touching a surface of the assigned device 108, pressing a button of the assigned device 108, operating a handle of the assigned device 108, making a gesture (e.g., a hand gesture) near the assigned device 108, speaking a verbal command near the assigned device 108, and/or approaching and/or touching a biometric scanner that is associated with the assigned device 108 (e.g., a fingerprint scanner, a retinal scanner, a camera-based user-identification system, so forth). As another example, the authentication procedure may begin when the user is located in the passenger compartment of the device. As another example, the authentication procedure may begin when the user is located in a seat within the compartment of the assigned device 108. As another example, the authentication procedure may begin when the assigned device 108 arrives at a specified location, such as at a current location of the user or a user-specified location.

In operation 542, authentication information is exchanged. Exchanging authentication information in operation 542 allows the assigned device 108 to confirm that the person who is attempting to access and/or use the assigned device 108 is authorized to do so (e.g., the user to whom the assigned device 108 is assigned or another person who has been given permission to access and or use the assigned device 108 by the user to whom the device is assigned). In operation 543, the authentication information from operation 542 is evaluated to determine whether authentication is successful. As an example, the authentication information can be evaluated by comparison to an expected value, such as by determining that authentication is successful if the authentication information matches the expected value and determining that authentication is not successful if the authentication information does not match the expected value.

If the exchange of authentication information from operation 542 indicates that the person who is attempting to access and/or use the assigned device 108 is authorized to do so, a successful authentication result is determined and the process proceeds to operation 544, in which the person attempting to access and/or use the assigned device 108 is permitted to do so, for example, by unlocking the assigned device 108, opening the assigned device 108, and/or accepting commands by the assigned device 108 that cause the device to travel from a current location to a destination. If the exchange of authentication information from operation 542 indicates that the person who is attempting to access and/or use the assigned device 108 is not authorized to do so, an unsuccessful authentication result is determined and the process proceeds to operation 545, in which access to and control of the assigned device 108 is not permitted.

In some implementations of operation 542, the user may provide authentication information to the assigned device 108 by inputting the authentication information to an input device that is associated with the assigned device 108. In some implementations of operation 542, the user may provide authentication information to the assigned device 108 by transmitting the authentication information to the assigned device 108 from the user device 110. In some implementations of operation 542, the user may provide authentication information to the assigned device 108 indirectly by transmitting the authentication information to the provider entity 102 or to a third party service, where the provider entity 102 or the third party service evaluates the authentication information and transmits information regarding the authentication result to the assigned device 108.

As an example of exchanging authentication information, a display that is associated with the assigned device 108 may show a login prompt to the user, and the user may provide authentication information to the assigned device 108 in the form of a username and password. The assigned device 108 may evaluate the username and password locally, or may transmit the username and password (using a secure and encrypted connection) to another system for evaluation, such as by transmitting the username and password to the provider entity 102 for evaluation.

As an example of exchanging authentication information, the assigned device 108 and/or the provider entity 102 may send a passcode to the user device 110. As examples, the passcode may be sent to the user device in an SMS protocol message, in an email, using an application, or otherwise. An input device that is associated with the assigned device 108 is usable by the user, from outside of the assigned device and/or from inside a passenger cabin of the assigned, for the purpose of inputting the passcode. Thus, the user may input the passcode that was received at the user device 110 using an input device that is associated with the assigned device 108 in order to provide the authentication information to the assigned device 108, which may evaluate the authentication information locally or may transmit the authentication information to the provider entity 102 for evaluation. In this example, the input device may be a keyboard style interface, such as a physical keyboard or a keyboard implemented using a touch-sensitive display device. Other types of input devices may be used. One example of an alternative input device is an audio input device (e.g., a microphone) that obtains an audio signal representing the user speaking the passcode. In such an implementation, the passcode could be a word or phrase that functions as authentication information by allowing comparison of text corresponding to the spoken passcode to an expected value. In addition, the spoken passcode can be evaluated to determine whether the voice and speech patterns correspond to the user, by an analysis, using known voice analysis techniques, that is based on speech that the user has previously provided for authentication purposes, such as during a configuration process.

As an example of exchanging authentication information, a biometric scanner that is associated with the assigned device 108 may be configured to obtain the authentication information from the user in the form of a biometric identifier that the user has provided for authentication purposes, such as during a configuration process. The authentication information can involve a biometric scan, such as a fingerprint scan, a retinal scan, one or more images of the user's face (e.g., a series of face images), a voice sample, so forth. The assigned device 108 may evaluate the biometric identifier (e.g., information representing the biometric scan), or may transmit the biometric identifier (using a secure and encrypted connection) to another system for evaluation, such as by transmitting the biometric identifier to the provider entity 102 for evaluation. The biometric identifier may be evaluated, for example by comparison of the biometric identifier with previously stored biometric information that is associated with the user.

As another example of exchanging authentication information, a display (e.g., a display screen) that is associated with the assigned device 108 may show a passcode to the user. As one example passcode may be a series of numbers, letters, and/or other characters. The display that shows the passcode may be viewable from outside of the device and/or may be viewable from inside the passenger cabin of the device. The passcode functions as authentication information to ensure that the user is attempting to access the correct device. The user may enter the passcode into the user device 110 and transmit the passcode from the user device 110 to the assigned device 108 and/or the provider entity 102 as authentication information. Verification of the user's identity (e.g., a username and password authenticating access to the user's account or a previous authentication of access to the user's account) may also be sent from the user device 110 to the assigned device 108 and/or the provider entity 102 as authentication information with transmission of the passcode. As an alternative to displaying the passcode on a display screen, the passcode may be audibly announced by the assigned device 108, for example, using an audio output device (e.g., a loudspeaker) that can be heard by the user when the user is outside of the assigned device 108 and/or inside the passenger compartment of the assigned device 108.

As another example of exchanging authentication information, the authentication information may include an indicia that is visible from the outside of and/or from the inside of the passenger compartment of the assigned device 108. In this usage, the term visible includes visible to a person and visible to a machine vision system, which may include indicia that are outside of the visible spectrum. As one example, the indicia may be printed, affixed, or otherwise placed on a surface of the assigned device 108, such as by printing of the indicia on a label that is adhered to a surface of the assigned device 108. The indicia may be displayed, such as by a display screen or other output device, in which case the indicia may be, as examples, a static image or a changing image. The user device 110 is used to perceive the indicia, such as by using sensors that are included in the user device. For example, a camera (e.g., a visible spectrum camera or an infrared camera) that is included in the user device 110 may be used to perceive the indicia, such as by obtaining an image that shows the indicia. As examples, the indicia may be a bar code (according to any suitable standard now known or later developed), a series of characters such as numbers and/or letters, a picture, so forth. The indicia functions as authentication information to ensure that the user is attempting to access the correct device. The user may capture a representation (e.g., and image) with the user device 110 and transmit the representation from the user device 110 to the assigned device 108 and/or the provider entity 102 as authentication information. Verification of the user's identity may also be sent from the user device 110 to the assigned device 108 and/or the provider entity 102 as authentication information with the representation of the indicia.

As another example of exchanging authentication information, the authentication information may be exchanged by transmission of a signal from the user device 110 to the assigned device 108 using a short range wireless communications link (e.g., a direct wireless connection) between the user device 110 and the assigned device 108. The short range wireless communications link may be established using any suitable protocol. The authentication information that is transmitted to the assigned device 108 from the user device 110 may be or include authentication information that is received by the user device 110 from the provider entity 102. This authentication information can then be compared to an expected value by the assigned device 108 (e.g., upon receipt of the expected value at the assigned device 108 from the provider entity 102) or may be transmitted from the assigned device 108 to the provider entity 102 for evaluation by comparison to the expected value, in which case the authentication result is subsequently transmitted from the provider entity 102 to the assigned device 108.

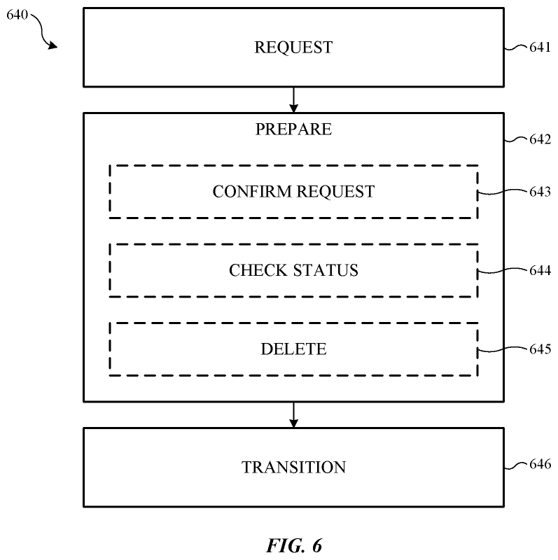

FIG. 6 is a block diagram of a process 640 for transitioning a device, such as the assigned device 108 in this example, from the assigned state to the unassigned state. As an example, the process 640 may include receiving a request for return of a device, preparing for return of the device to the unassigned state, transitioning the device from the assigned state to the unassigned state, and moving the device.

In operation 641, a request for return of the assigned device 108 is received. The request for return of the assigned device is a request to transition the device from the assigned state to the unassigned state and thereby return the assigned device to the device pool 104. In some situations, the request may be received by the provider entity 102, for example, in the form of a transmission from a device and/or location that is external to the provider entity 102 using the communications channels 112. The device that is external to the provider entity 102 may be, for example, the assigned device 108 or the user device 110. In some situations, the request may be initiated by a function, system, or person associated with the provider entity 102.

In some circumstances, the request for return of the assigned device 108 may be made by a user on may be made on behalf of a user. Thus, the request may be associated with a user account that is controlled by the user. The request may be made by a user through use of the user device 110, such as by submission of the request using an application that is executed by the user device 110. The request may be made by a user through use of an interface device that is associated with the assigned device 108 (e.g., located in the passenger compartment of the assigned device 108), such as by submission of the request using an application that is executed by the assigned device 108. As an example, the request may be made by operation of a physical button that is located in the passenger cabin of the assigned device 108 or a button displayed on a touch-sensitive display screen that is located in the passenger cabin of the assigned device 108, in order to allow the user to end the usage period of the device by operation of the physical button or displayed button.

In some circumstances, the request for return of the assigned device 108 may be initiated by the assigned device 108. As an example, the assigned device 108 may transmit, to the provider entity 102, a request to return to the unassigned state in response to satisfaction of a condition, such as the expiration of a time period for usage of the assigned device 108 by the user or arrival of the assigned device 108 at a destination location, if the usage period corresponds to a predefined trip. In some circumstances, the request for return of the assigned device 108 may be initiated at the provider entity 102, in response to satisfaction of a condition, as described with respect to requests made by the assigned device 108, or for any other reason.

Operation 642 includes preparing for return of the assigned device 108 from the assigned state to the unassigned state. Operation 642 may include taking one or more actions in preparation for return of the assigned device 108 to the unassigned state. Operation 642 may include determining whether one or more conditions are satisfied in preparation for return of the assigned device 108 to the unassigned state, wherein transition to the unassigned state is not allowed to proceed until it is determined that the one or more conditions are satisfied. Operation 642 may include optional sub-operations that are performed as part of preparing the assigned device 108 for return to the unassigned state. In particular, operation 642 may include confirming the request in sub-operation 643, checking a status of the assigned device in sub-operation 644, and deleting user information from the assigned device 108 in sub-operation 645. In some implementations, preparing the device to transition to the unassigned state includes performing one or more of the sub-operations, and the device is prevented from transitioning to the unassigned state until it is determined that the one or more sub-operations have been completed.

Sub-operation 643 includes confirming the request made in operation 641 for return of the assigned device 108 to the unassigned state. Sub-operation 643 may be performed when the request is made by the provider entity 102 or by the assigned device 108, in order to confirm that the user is ready to allow the assigned device 108 to be returned to the unassigned state. Thus, in situations where the request is made by at least one of the provider entity 102 or the assigned device 108, preparing to transition to the unassigned state may include receiving confirmation from the user that the user is ready to allow transition of the assigned device 108 from the assigned state to the unassigned state.

As one example, the assigned device 108 may request confirmation from the user by displaying a message on an interface device, such as a display screen, where the message request a user input indicating whether the user is ready to allow transition of the assigned device 108 to the unassigned state. The user may make an input using the interface device that indicates that they are ready to allow transition of the assigned device 108 to the unassigned state, or may indicate that they are not ready, for example, in order to extend a trip to a new destination or to provide additional time for unloading cargo items. As another example, the message requesting a user input indicating whether the user is ready to allow transition of the assigned device 108 to the unassigned state may be displayed on a display screen of a device other than the assigned device 108, such as the user device 110.

Sub-operation 644 includes checking the status of the assigned device 108 to determine whether the assigned device 108 is allowed to return to the unassigned state. Checking the status of the assigned device 108 can include determining whether one or more conditions for transition to the unassigned state are satisfied according to the status of the assigned device 108, wherein the assigned device is not allowed to transition from the assigned state to the unassigned state until all of the conditions are satisfied. As an example, checking the status of the assigned device 108 may include determining whether the assigned device 108 is currently traveling (e.g., in motion, following a route toward a destination, so forth), wherein the assigned device 108 is not allowed to transition to the unassigned state while it is traveling. As an example, checking the status of the assigned device 108 may include determining whether passengers are located in the assigned device 108 (e.g., determined using sensors such as cameras located inside the passenger compartment of the vehicle in combination with machine vision techniques), wherein the assigned device 108 is not allowed to transition to the unassigned state while passengers are in the assigned device. As an example, checking the status of the assigned device 108 may include determining whether cargo items are located in the assigned device 108, wherein the assigned device 108 is not allowed to transition to the unassigned state while cargo items are in the assigned device 108. As an example, presence of cargo items in the assigned device 108 may be determined using sensors such as cameras in combination with machine vision techniques. As an example, presence of cargo items in the assigned device 108 may be determined using wireless tracking devices that are attached to the cargo items and can be sensed by sensors associated with the assigned device 108. As an example, checking the status of the assigned device 108 may include determining a location of the assigned device 108, wherein the assigned device 108 is not allowed to transition to the unassigned state unless the current location of the assigned device meets one or more predetermined requirements (e.g., specifying a safe and appropriate location for loading and unloading, located within a predetermined area, so forth).

Sub-operation 645 includes deleting user information from the assigned device 108 and functions to ensure that no user-specific information remains stored by the assigned device when the usage period has concluded, and the assigned device 108 returns to the unassigned state. All information relating to the user, user preferences, and usage of the assigned device by the user is deleted. As examples, prior to deletion, the user information that is deleted in sub-operation 645 may be stored by the various systems of the assigned device 108. As an example, the navigation system 326 of the assigned device may store user information that describes a user's favorite destinations and/or previous trips taken by the user. As an example, the control system 330 may store user information describing device configuration settings, such as seating configuration settings and climate control settings. As an example, the infotainment system 332 may store user information such as contact information for persons who have been called or messaged by the user, internet browsing history, audio playlists, video watching history, so forth. Optionally, infotainment system 332 or another display may present an indication to the user that user information are being deleted at the conclusion of the trip and/or usage period.

As an example, deleting all stored user information from the assigned device 108 may be performed at a conclusion of a usage period. The conclusion of the usage period may correspond to arrival at a destination location, a predefined end time associated with the usage period, transition of transportation device to the unassigned state from the assigned state, so forth.

Operation 646 includes transitioning the assigned device 108 from the assigned state to the unassigned state. As a result of operation 646, the respective device no longer functions as the assigned device 108 and instead functions as one of the available devices 106 as part of the device pool 104 and may be made available for assignment to other users. In some implementations, the transitioning the assigned device 108 from the assigned state to the unassigned state cannot be performed until preparing for return of the assigned device 108 from the assigned state to the unassigned state is completed as described with respect to operation 642 and optional sub-operations 643-645. In some implementations, the provider entity 102 and/or the assigned device 108 prevents transition of the assigned device 108 from the assigned state to the unassigned state until confirming the request has been completed as described with respect to sub-operation 643. In some implementations, the provider entity 102 and/or the assigned device 108 prevents transition of the assigned device 108 from the assigned state to the unassigned state until checking the status of the assigned device 108 has been completed as described with respect to sub-operation 644. In some implementations, the provider entity 102 and/or the assigned device 108 prevents transition of the assigned device 108 from the assigned state to the unassigned state until deleting user information has been completed as described with respect to sub-operation 645. In some implementations, transitioning the assigned device 108 from the assigned state to the unassigned state is only performed after determining that all conditions from a group of one or more of the conditions described in connection with operation 642 and/or sub-operations 643-645 are satisfied. As an example, in some implementations, transitioning the assigned device 108 from the assigned state to the unassigned state is only performed after deleting user information from the navigation system 326.

In the description herein, transition from the assigned state to the unassigned state is described as occurring subsequent to certain operations, such as deleting user information in optional sub-operation 645. It should be understood, however, that delivering the assigned device 108 to the user in accordance with operation 444 and its sub-operations. It should be understood that order of these operations can be modified, and some operations may be performed concurrently.

Subsequent to return to the unassigned state, the assigned device 108 is now referred to as the available device 106. The available device 106 may be moved under autonomous control at the direction of the provider entity 102, such as to a designated storage location for the available device 106, to a maintenance location, or to a pick up location for a different user. FIG. 7 illustrates exemplary computing device 750. The computing device 750 is an example of a hardware device that can be used as a basis for implementing computer-based systems, control systems, and/or other processing systems that are described herein, such as components of the system 100 and including portions of the provider entity 102, the available device 106, the assigned device 108, and the user device 110. In the illustrated example, the computing device 750 includes a processor 751, memory 752, storage 753, and communication devices 754. The computing device 750 may include other components, such as, for example, input devices and output devices.

The processor 751 may be in the form of one or more conventional devices and/or more or more special-purpose devices that allow the computing device 750 to execute computer program instructions. Implementations of the processor 751 may include one or more central processing units, one or more graphics processing units, one or more application specific integrated circuits, and/or one or more field programmable gate arrays. The memory 752 provides short-term storage to the processor 751 and may be in the form of conventional memory devices, which may be volatile high-speed memory such as random-access memory modules. Long-term storage of computer program instructions and other data is provided by the storage 753, which is a non-volatile information storage device such as a flash memory module, a hard drive, or a solid-state drive. The communication devices 754 include any manner or wired or wireless interface that allows the computing device to communicate with other components or systems, such as by sending data transmission and receiving data transmissions.

The computing device 750 is operable to store, load, and execute computer program instructions. When executed by the computing device 750, the computer program instructions cause the computing device to perform operations.

The operations that can be performed by the computing device 750 may include obtaining information. Examples of obtaining information include accessing the information from a storage device, accessing the information from short-term memory, receiving a wired or wireless transmission that includes the information, receiving signals from an input device that represent user inputs, and receiving signals from the sensors that represent observations made by the sensors.

The operations that can be performed by the computing device 750 may include making a determination. Examples of making a determination include comparing a value to a threshold value, comparing states to conditions, evaluating one or more input values using a formula, evaluating one or more input values using an algorithm, and/or making a calculation using data of any type.

The operations that can be performed by the computing device 750 may also include transmitting information. Information may be transmitted between components of a single system, for example, using a data bus. Information may be transmitted to a remote system, for example, by a wired data transmission or wireless data transmission.

The operations that can be performed by the computing device 750 may also include outputting a signal to control a component. One example of a signal to control a component is a signal that causes a sensor to take a measurement. Another example of a signal to control a component is a signal that causes a camera to capture an image. Another example of a signal to control a component is a signal that causes operation of an actuator, such as by commanding the actuator to start moving, stop moving, set a speed value, set a torque value, or move to a particular position that is specified by the signal.

The operations that can be performed by the computing device 750 may also include outputting a display signal that causes a display component to present content. The types of display components to which the signal may be output may include, for example, a light-emitting display panel, a projector, or other type of display device that is able to present content in a manner that can be seen by a person.

The above-described techniques contemplate the use of data that are helpful in day-to-day operations of electronic devices, including information such as frequent destinations, infotainment system settings, user preferences, so forth. In addition, the described techniques also contemplate, in situations involving a pool of multiple devices that may be assigned amongst users, that an electronic device retains information only retains information associated with a user during the usage period in which the electronic device is assigned to the user. Put another way, user input may be deleted the electronic device transitions to a different user or returns to an unassigned state. Entities that are implementing electronic assignment infrastructure are reminded to consider taking steps, including those described above, to safeguard user information and to ensure that information are handled in ways consistent with established privacy practices and/or regulations.

What is claimed is:

1. An apparatus, comprising:
one or more processors coupled to a memory and a motion actuator, wherein the memory comprises instructions that, when performed using the one or more processors, cause the apparatus to:
receive an assignment request, wherein the assignment request specifies a usage period, of the apparatus, for a user;
authenticate a potential user, in accordance with the assignment request, as the user associated with the usage period;
move, using the motion actuator, towards a destination in accordance with input specified by the authenticated user and a motion plan determined using the one or more processors; and
in accordance with arrival at the destination and a determination that the usage period has expired, delete the input specified by the authenticated user from the memory.

2. The apparatus of claim 1, wherein the memory further comprises that, when performed using the one or more processors, cause the apparatus to:
in accordance with a determination that the usage period has not expired, retain at least portions of the input specified by the authenticated user in the memory, beyond arrival at the destination.

3. The apparatus of claim 2, wherein the memory further comprises instructions that, when performed using the one or more processors, cause the apparatus to:
in accordance with a determination that the usage period has expired, delete input provided by the authenticated user during the usage period from the memory.

4. The apparatus of claim 1, wherein the memory further comprises instructions that, when performed using the one or more processors, cause the apparatus to:
configure the apparatus according to preferences associated with the user, before authenticating the potential user as the user, and wherein deleting the input specified by the authenticated user comprises deleting data representing the preferences from the memory.

5. The apparatus of claim 1, wherein the input specified by the authenticated user includes the destination.

6. The apparatus of claim 1, wherein the memory further comprises instructions that, when performed using the one or more processors, cause the apparatus to:
present, on a display, an indication that information associated with the authenticated user are deleted on arrival at the destination.

7. The apparatus of claim 1, wherein the memory further comprises instructions that, when performed using the one or more processors, cause the apparatus to:
in accordance with receiving a device un-assignment request during the usage period, deleting information associated with the user from the memory, before the end of the usage period.

8. A method, comprising:
at an electronic device having memory and a motion actuator coupled to one or more processors:
receiving an assignment request, wherein the assignment request specifies a usage period, of the electronic device, for a user;
authenticating a potential user, in accordance with the assignment request, as the user associated with the usage period;
moving, using the motion actuator, towards a destination in accordance with input specified by the authenticated user and a motion plan determined using the one or more processors; and
in accordance with arrival at the destination and a determination that the usage period has expired, deleting the input specified by the authenticated user from the memory of the electronic device.

9. The method of claim 8, further comprising:
in accordance with a determination that the usage period has not expired, retaining at least portions of the input specified by the authenticated user in the memory of the electronic device, beyond arrival at the destination.

10. The method of claim 9, further comprising:
in accordance with a determination that the usage period has expired, deleting input provided by the authenticated user during the usage period from the memory of the electronic device.

11. The method of claim 8, further comprising:
configuring the electronic device according to preferences associated with the user, before authenticating the potential user as the user, and wherein deleting the input specified by the authenticated user comprises deleting data representing the preferences from the memory of the electronic device.

12. The method of claim 8, wherein the input specified by the authenticated user includes the destination.

13. The method of claim 8, further comprising: presenting, on a display, an indication that information associated with the authenticated user are deleted on arrival at the destination.

14. The method of claim 8, further comprising:
in accordance with receiving a device un-assignment request during the usage period, deleting information associated with the user from the memory, before the end of the usage period.

15. A non-transitory computer-readable storage device including program instructions executable by one or more processors of an electronic device that, when executed, cause the electronic device to perform operations comprising:
receiving, an assignment request, wherein the assignment request specifies a usage period, of the electronic device, for a user;
authenticating a potential user, in accordance with the assignment request, as the user associated with the usage period;
moving, using the motion actuator, towards a destination in accordance with input specified by the authenticated user and a motion plan determined using the one or more processors; and
in accordance with arrival at the destination and a determination that the usage period has expired, deleting the input specified by the authenticated user from the memory of the electronic device.

16. The non-transitory computer-readable storage device of claim 15, wherein the operations further comprise:
in accordance with a determination that the usage period has not expired, retaining at least portions of the input specified by the authenticated user in the memory of the electronic device, beyond arrival at the destination.

17. The non-transitory computer-readable storage device of claim 16, wherein the operations further comprise:
in accordance with a determination that the usage period has expired, deleting input provided by the authenticated user during the usage period from the memory of the electronic device.

18. The non-transitory computer-readable storage device of claim 15, wherein the operations further comprise:
configuring the electronic device according to preferences associated with the user, before authenticating the potential user as the user, and wherein deleting the input specified by the authenticated user comprises deleting data representing the preferences from the memory of the electronic device.

19. The non-transitory computer-readable storage device of claim 15, wherein the input specified by the authenticated user includes the destination.

20. The non-transitory computer-readable storage device of claim 15, wherein the operations further comprise:
presenting, on a display, an indication that information associated with the authenticated user are deleted on arrival at the destination.

21. The non-transitory computer-readable storage device of claim 15, wherein the operations further comprise:
in accordance with receiving a device un-assignment request during the usage period, deleting information associated with the user from the memory, before the end of the usage period.
